(19) United States
(12) Patent Application Publication
(10) Pub. No.: US 2026/0339144 A1
(43) Pub. Date: Oct. 29, 2026

(54) LIQUID CRYSTAL ELASTOMER COMPOSITIONS

(71) Applicant: Impressio Inc., Denver, CO (US)

(72) Inventors: Amir H. Torbati, Westminster, CO (US); Lyssa A. Bell, Littleton, CO (US); Carl P. Frick, Arvada, CO (US); Christopher M. Yakacki, Orlando, FL (US); Risheng Zhou, Englewood, CO (US)

(73) Assignee: Impressio Inc., Denver, CO (US)

(21) Appl. No.: 19/099,702

(22) PCT Filed: Jul. 28, 2023
(86) PCT No.: PCT/US2023/028965

§ 371 Date: Jan. 29, 2025

Related U.S. Application Data
(60) Provisional application No. 63/369,776, filed on Jul. 29, 2022.

(51) Int. Cl. G02F 1/1334

(52) U.S. Cl. CPC G02F 1/13345

(57) ABSTRACT

A light system includes a protective LCE layer disposed relative to a light source of the light system so that light emitted from the light source passes through the protective LCE layer. The light source may be any of a variety of light sources, including an LCD display, an LED, an array of LEDs, and the like. In some aspects, the protective LCE layer may be formed from monodomain LCE. In some aspects, the protective LCE layer may be formed from polydomain LCE.

### CROSS-REFERENCE TO RELATED APPLICATIONS

This patent application claims priority from, and incorporates by reference the entire disclosure of, U.S. Provisional Application No. 63/369,776 filed on Jul. 29, 2023.

### TECHNICAL FIELD

The present disclosure relates generally to liquid crystal elastomer (LCE) compositions and more particularly, but not by way of limitation, to the use of LCE as part of a display.

### BACKGROUND

This section provides background information to facilitate a better understanding of the various aspects of the disclosure. It should be understood that the statements in this section of this document are to be read in this light, and not as admissions of prior art.

Flat screen displays are in wide use. There are a variety of different types of technologies used to create flat screen displays, including liquid crystal displays (“LCD”), plasma displays, electroluminescent (EL) displays, field emission displays, and the like. While these technologies all work in different manners, each includes a screen that displays an image to a user. Each type of display also includes a display surface that is typically the outer most layer of the display. The display surface is meant to protect the internal components of the display from damage. To perform well, the display surface must meet certain performance metrics with respect to strength and transmissivity.

### SUMMARY

This summary is provided to introduce a selection of concepts that are further described below in the Detailed Description. This summary is not intended to identify key or essential features of the claimed subject matter, nor is it to be used as an aid in limiting the scope of the claimed subject matter.

A light system includes a protective LCE layer disposed relative to a light source of the light system so that light emitted from the light source passes through the protective LCE layer. The light source may be any of a variety of light sources, including an LCD display, an LED, an array of LEDs, and the like. In some aspects, the protective LCE layer may be formed from monodomain LCE. In some aspects, the protective LCE layer may be formed from polydomain LCE.

In various aspects, a display surface for a display includes an LCE sheet. In some aspects the LCE sheet comprises monodomain LCEs. In some aspects the LCE sheet comprises polydomain LCEs.

In some aspects, LCE sheet is comprised of monodomain LCE and comprises the following properties: a haze of about 3.34%; a transmission of about 90.7%; a sharpness of about 93.99%; and a clarity of about 99.01%.

In some aspects, the LCE sheet is comprised of monodomain LCE and has a thermal conductivity along the fiber of about 0.33 to about 0.37 W/mK.

In some aspects, the LCE sheet is comprised of monodomain LCE and has a thermal conductivity across the fiber of about 0.16 to about 0.19 W/mK.

In some aspects, the LCE sheet is comprised of monodomain LCE and has a thermal diffusivity along the fiber of about 0.1 to about 0.115 mm²/s.

In some aspects, the LCE sheet is comprised of monodomain LCE and has a thermal diffusivity across the fiber of about 0.07 to about 0.09 mm²/s.

In some aspects, the LCE sheet is comprised of polydomain LCE and has a thermal conductivity of about 0.222 W/mK.

In some aspects, the LCE sheet is comprised of polydomain LCE and has a thermal diffusivity of about 0.1 to about 0.115 mm²/s.

In some aspects, the LCE sheet is comprised of polydomain LCE and has a specific heat of about 1.9 to about 2.04 MJ/m³ k.

In various aspects, a light system includes a light source and a protective LCE layer disposed relative to the light source so that light emitted from the light source passes through the LCE layer.

In some aspects, the protective LCE layer is comprised of monodomain LCE and comprises the following properties: a haze of about 3%; a transmission of about 90%; a sharpness of about 93%; and a clarity of about 99%.

In some aspects, the protective LCE layer is comprised of monodomain LCE and has a thermal conductivity along the fiber of about 0.33 to about 0.37 W/mK.

In some aspects, the protective LCE layer is comprised of monodomain LCE and has a thermal conductivity across the fiber of about 0.16 to about 0.19 W/mK.

In some aspects, the protective LCE layer is comprised of monodomain LCE and has a thermal diffusivity along the fiber of about 0.1 to about 0.115 mm²/s.

In some aspects, the protective LCE layer is comprised of monodomain LCE and has a thermal diffusivity across the fiber of about 0.07 to about 0.09 mm²/s.

In some aspects, the protective LCE layer is comprised of polydomain LCE and has a thermal conductivity of about 0.222 W/mK.

In some aspects, the protective LCE layer is comprised of polydomain LCE and has a thermal diffusivity of about 0.1 to about 0.115 mm²/s.

In some aspects, the protective LCE layer is comprised of polydomain LCE and has a specific heat of about 1.9 to about 2.04 MJ/m³ k.

In some aspects, the light source is selected from the group consisting of an LCD display, an OLED display, a mobile device, a table, a smartwatch, an LED, an array of LEDs.

In some aspects, the light source is a foldable display.

### BRIEF DESCRIPTION OF THE DRAWINGS

A more complete understanding of the subject matter of the present disclosure may be obtained by reference to the following Detailed Description when taken in conjunction with the accompanying Drawings wherein:

FIG. 1 illustrates mesogen orientation in polydomain (left) and monodomain (right) main-chain LCEs;

FIGS. 2(a)-2(d) illustrate a two-stage thiol-acrylate reaction to synthesize and program LCE: FIG. 2(a) illustrates chemicals used for synthesis, FIG. 2(b) illustrates a polydomain state after the Michael addition reaction, FIG. 2(c) illustrates stretching used to orient the mesogens into a monodomain, and FIG. 2(d) illustrates an anisotropic monodomain after UV-crosslinking;

FIGS. 3A and 3B are graphs of stress versus strain for axial and lateral loading of an LCE sample according to aspects of the disclosure;

FIGS. 4A and 4B are graphs of load versus displacement and modulus versus displacement, respectively, for an LCE sample according to aspects of the disclosure;

FIG. 5 is a schematic illustration of a touch-screen display with a protective LCE layer according to aspects of the disclosure; and

FIG. 6 is a schematic illustration of a light source with a protective LCE layer according to aspects of the disclosure.

### DETAILED DESCRIPTION

It is to be understood that the following disclosure provides many different embodiments, or examples, for implementing different features of various embodiments.

Specific examples of components and arrangements are described below to simplify the disclosure. These are, of course, merely examples and are not intended to be limiting. The section headings used herein are for organizational purposes and are not to be construed as limiting the subject matter described. Reference will now be made to more specific embodiments of the present disclosure and data that provides support for such embodiments. However, it should be noted that the disclosure below is for illustrative purposes only and is not intended to limit the scope of the claimed subject matter in any way.

LCE's are crosslinked polymer networks that exhibit the anisotropic properties of liquid crystals and the elastic behaviors of rubbers. The combination of these properties makes LCE's adaptable to a wide range of uses. The instant disclosure focuses on using LCE's as part of a transmissive display. To demonstrate the effectiveness of LCE's as a part of a transmissive display, various properties of LCE samples were tested, including thermal conductivity, thermal diffusivity, specific heat, transparency, transmission, sharpness, clarity, and stress.

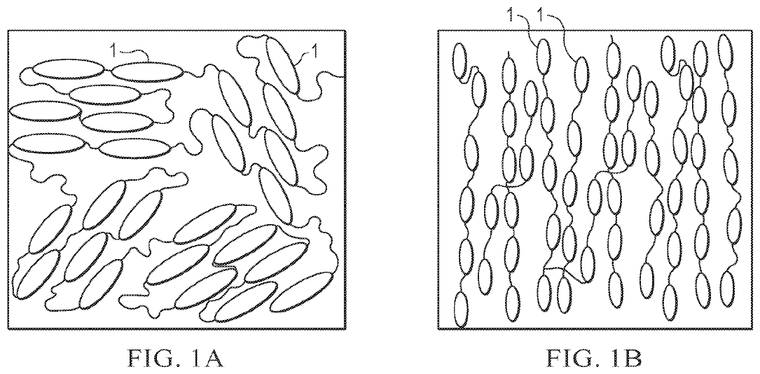

LCEs are a class of multi-functional polymers that combine network elasticity with liquid-crystalline order. Liquid crystals are comprised of rigid aromatic rings known as mesogens. Liquid-crystal order arises when mesogens self-organize, which can exist in two states: polydomain and monodomain. FIG. 1A illustrates the polydomain state in which mesogens 1 are arranged into randomly oriented domains that provide significant damping and energy dissipation. FIG. 1B illustrates the monodomain state in which the mesogens 1 are aligned to increase strength, while being mechanically anisotropic. When locked into a polymer network, mesogen order gives the material unique abilities such as tailored gradients and anisotropy, reversible actuation like a muscle, and the ability for extreme energy dissipation compared to traditional hydrogels, rubbers and elastomers.

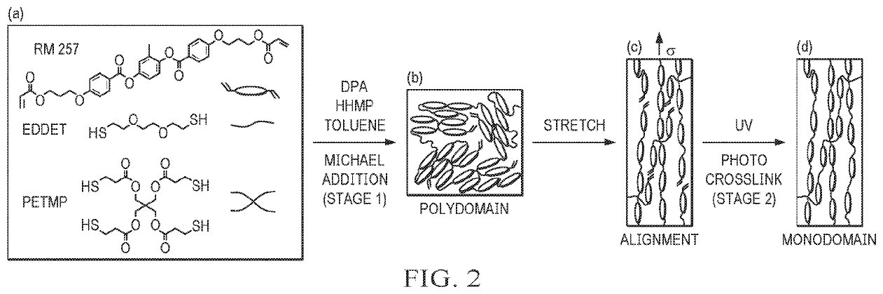

LCE synthesis and preparation is not a trivial process. Main-chain LCEs are defined by synthesizing the mesogens directly into the polymer backbone and show ideal coupling behavior leading to extraordinary properties; however, this process has been a longstanding challenge in the field of LCEs. The majority of researchers use a step-growth hydrosilylation reaction, which requires high-purity materials and careful experimental conditions. To tailor the liquid-crystalline structure into a monodomain, mesogens must be manually oriented during synthesis. Using hydrosilylation reactions, one technique is to allow the material to gel, stretch the gel to orient the mesogens and chains, and then allow the reaction to finish crosslinking the material. This technique is inherently difficult to repeat. Non-mechanical methods such as surface alignment and magnetic fields can also be applied to align mesogens into a monodomain. These methods must be used for one-step reactions that cannot be stopped and restarted, such as free radical reactions. Also, these reactions are limited to samples less than 100 μm thick. Recently, we have developed a new technique to create tailored main-chain LCEs with unprecedented control over scalability, thermo-mechanical properties, and mesogen order. FIGS. 2(a)-2(d) illustrates a two-stage thiol-acrylate reaction with which large LCE samples can be synthesized and tailored to exploit the unique properties of LCEs.

Tables 1 and 2 below report values of thermal conductivity and thermal diffusivity of monodomain and polydomain LCE's at different temperature points. Thermal conductivity and thermal diffusivity were measured at different temperatures using the equipment and parameters described below, all in accordance with ISO 22007-2. Testing was performed with a Hot Disk® TPS 3500. The LCE samples tested had a thickness of 1 mm. Testing included the standard isotropic Hot Disk® method, the anisotropic hot strip method, and Hot Disk® specific heat capacity method. The following sensor types were used: hot strip 5081 (20 mm×6.4 mm), Hot Disk® 5501 Kapton (radius 6.4 mm), and Hot Disk® 5462 Kapton (radius 3.2 mm).

TABLE 1
Thermal transport properties of LCE
Monodomain at different temperatures

| | Thermal | | Thermal | Thermal |
|---|---|---|---|---|
| | conductivity | Thermal | conductivity | diffusivity |
| | along the | diffusivity | across the | across the |
| Temperature | fiber | along fiber | fiber | fiber |
| (°C) | (W/mK) | (mm²/s) | (W/mK) | (mm²/s) |
| 9.99 | 0.3707 | 0.1749 | 0.1886 | 0.0889 |
| 21 | 0.3578 | 0.1688 | 0.1857 | 0.0875 |
| 50.07 | 0.3311 | 0.1562 | 0.1632 | 0.077 |

TABLE 2
Thermal transport properties of LCE Polydomain
sample at different temperatures

| | Thermal | Thermal | |
|---|---|---|---|
| Temperature | conductivity | diffusivity | Specific heat |
| (°C) | (W/mK) | (mm²/s) | (MJ/m³k) |
| 10.75 | 0.2222 ± 0.0004 | 0.1154 ± 0.0012 | 1.926 ± 0.02 |
| 20.8 | 0.2229 ± 0.00067 | 0.1099 ± 0.0007 | 2.029 ± 0.0078 |
| 47.57 | 0.2214 ± 0.0007 | 0.1087 ± 0.0015 | 2.037 ± 0.02 |

Transparency versus wavelength for a monodomain LCE sample was tested. The monodomain LCE sample demonstrated transmittance of greater than 80% for wavelengths greater than about 420 nm, and over 85% for wavelengths greater than about 450 mm. A Rhopoint ID-L Transmission Appearance Meter was also used to measure haze, transmission, sharpness, and clarity of a monodomain LCE sample having a thickness of 0.75 mm: haze 3.34%; transmission 90.7%; sharpness 93.99%; and clarity 99.01%. Polydomain LCE have lower transmission, and can be useful when diffusing light is desirable (e.g., for light fixtures and decorative lighting).

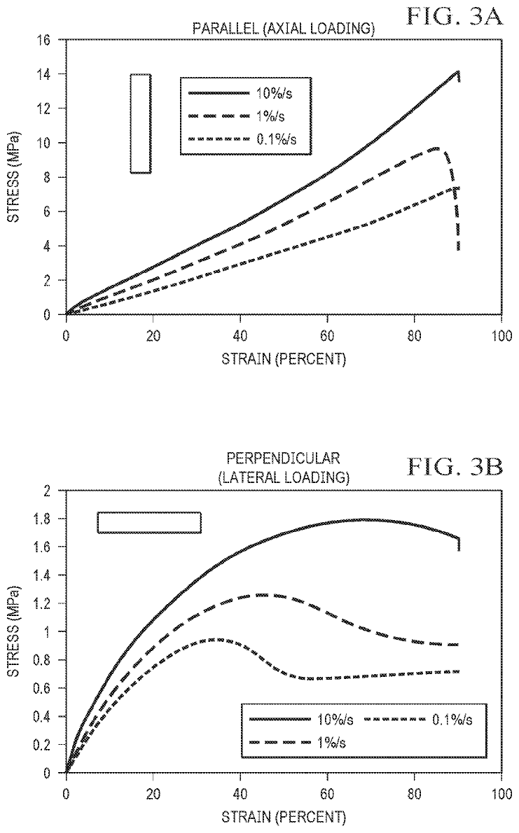

FIGS. 3A and 3B are graphs of stress versus strain for axial and lateral loading, respectively, of a monodomain LCE sample according to aspects of the disclosure. The LCE sample dissipated more energy as the applied strain rate increased, both when loaded axially as well as when loaded laterally. Energy dissipation was almost an order of magnitude higher when the material was loaded axially as compared being loaded laterally. These test results also demonstrate the sample's impact resistance capabilities. Thermoplastic polyurethanes are commonly used in applications where impact resistance is important. Table 3 below illustrates strain rate for a sample with a thickness of 0.75 mm.

TABLE 3
Strain rate for monodomain LCE

| | Strain Rate | | |
|---|---|---|---|
| Monodomain LCE | 10⁻³ | 10⁻² | 10⁻¹ |
| Parallel | 2.39 | 3.31 | 4.04 |
| Perpendicular | 0.54 | 0.72 | 0.97 |

These test results illustrate LCEs offer improved impact resistance compared to thermoplastic polyurethanes (“TPUs”). TPUs are also thermally resistant while LCEs are thermally conductive (and therefore have a lower thermal resistance) as compared to TPUs. TPUs are widely used for display applications, including flexible displays. LCEs are well suited for use in these applications due to their superior thermal conductance and impact resistance performance compared to TPUs. LCEs are soft at temperatures from about 0 °C to about 70 °C. This makes LCEs applicable for applications at or near ambient temperature, such as display applications.

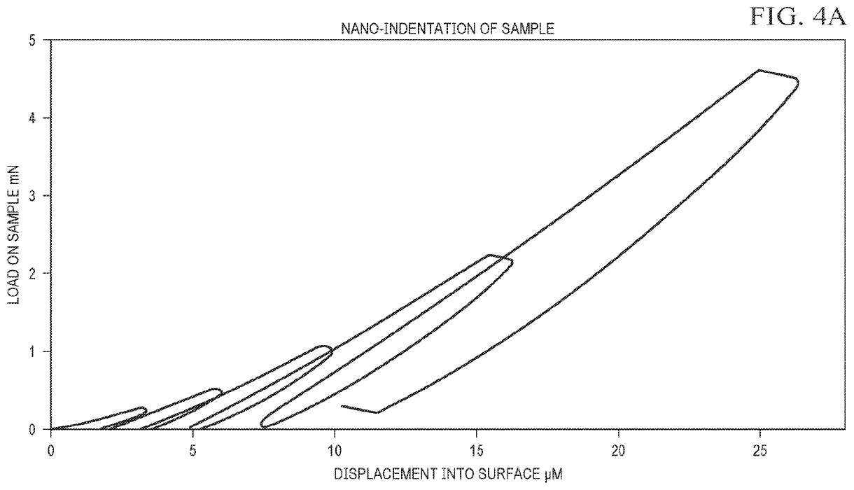

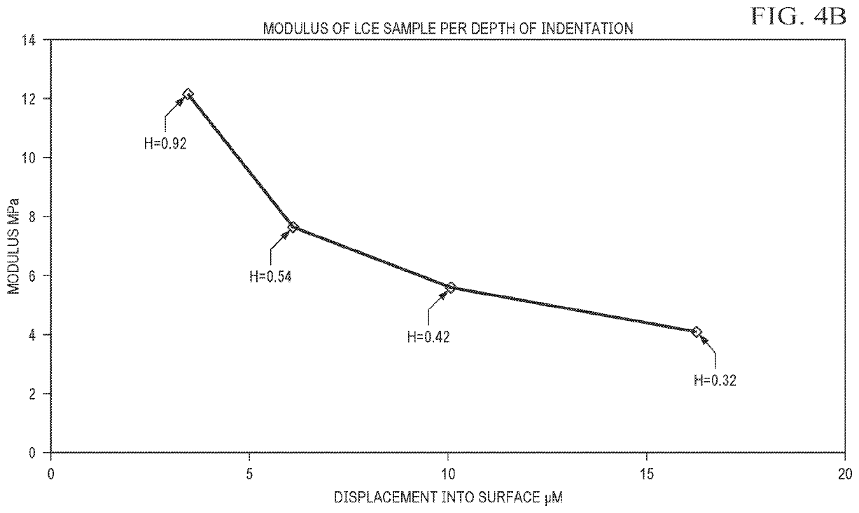

FIGS. 4A and 4B are graphs of load versus displacement and modulus versus displacement, respectively, for a monodomain LCE sample according to aspects of the disclosure. An LCE sample was subjected to nano-indentation testing using an Agilent Technologies G200 with Accutip. The LCE sample displayed hysteretic behavior during testing; however, given time to recover, the sample recovered completely. Micro-indentation testing was performed on an LCE sample having a thickness of 0.75 mm using a Buehler Micromet II with diamond Vicker's tip.

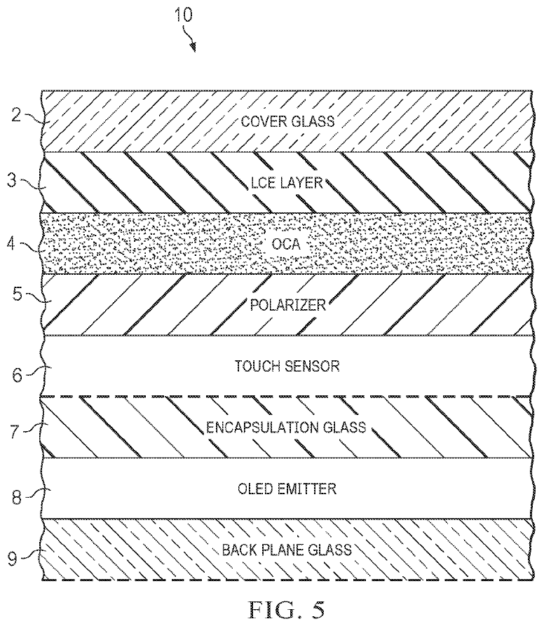

FIG. 5 is a schematic illustration of a touch-screen display with a protective LCE layer according to aspects of the disclosure. As discussed above, LCEs have desirable properties compared to conventional materials, making them suitable for use in a wide variety of applications. There are numerous different types of display technologies, with liquid crystal displays (“LCD”) being among the most prevalent. Among LCD displays, there are various types include light emitting diode (“LED”) and organic LED (OLED) displays. LCD displays contain various components that are typically arranged in layers within a housing or frame. The component layers may include, for example, a print circuit board, a polarizer, a light source (e.g., LEDs or other sources of light), color filter, cover glass, touch sensor, optically clear adhesive (“OCA”), etc. An outer most layer of the LCD display is a display surface that is designed to protect the components of the LCD display. In addition to protecting the components of the LCD display, the display surface must allow light generated by the LCD display to pass therethrough to be visible to a user. LCEs are well suited for use as the display surface or in combination with existing display surfaces, as LCEs provide both the protection/strength needed to protect the internal components of the LCD display and the transmissivity needed to allow the light generated by the LCD display (i.e., the picture) to pass through for clear viewing.

Referring still to FIG. 5, an illustrative display 10 is shown schematically. Display 10 is illustrated as being a touchscreen OLED display. Display 10 includes a cover glass 2, an LCE layer 3, an OCA 4, a polarizer 5, a touch sensor 6, an encapsulation glass 7, an OLED emitter 8, and a back plane glass 9. Display 10 is merely illustrative, and more or fewer layers could be present in various displays. For example, for a non-touchscreen display, the touch sensor could be omitted etc. In other aspects, display 10 may be a flexible or foldable display. LCEs are well suited to foldable displays given their strength and flexibility. As shown in FIG. 5, LCE layer 3 is used in conjunction with cover glass 2. LCE layer 3 comprises monodomain LCE, as monodomain LCE has greater transmissivity compared to polydomain LCE. By using LCE layer 3 with cover glass 2, the overall strength of the protective layer is increased. In some aspects, cover glass 2 may be omitted and LCE layer 3 is the outer most layer. Using LCE in display 10, with or without cover glass 2 provides superior protection to the internal components (e.g., print circuit board, polarizer, color filter, back light unit, and the like) of Display 10. In various aspects, display 10 can be incorporated into an LCD television (e.g., for home or commercial use), the display of a laptop, a computer monitor display, a mobile device (e.g., a phone or a tablet), a smartwatch, a vehicle's gauge cluster, head-up display, and the like.

In some aspects, LCE layer 3 is between about 50-150 μm thick, but may be thinner or thicker depending upon the application. In some aspects, LCE layer 3 is configured with monodomain LCE to have a haze of about 3.34%, a transmission of about 90.7%, a sharpness of about 93.99%, and a clarity of about 99.01%. In various aspects, LCE layer 3 is configured with monodomain LCE to have a haze of between about 1-5%, a transmission of about 85-93%, a sharpness of about 90-95%, and a clarity of about 95-99%. In some aspects, LCE layer 3 is configured with monodomain LCE to have a thermal conductivity along fibers of the monodomain LCE of about 0.33-0.37 W/mK. In some aspects, LCE layer 3 is configured with monodomain LCE to have a thermal conductivity across the fiber of about 0.16-0.19 W/mK. In some aspects, LCE layer 3 is configured with monodomain LCE to have athermal diffusivity along the fiber of about 0.1 to about 0.115 mm²/s. In some aspects, LCE layer 3 is configured with monodomain LCE to have a thermal diffusivity across the fiber of about 0.07 to about 0.09 mm²/s. In some aspects, LCE layer 3 is configured with polydomain LCE to have a thermal conductivity of about 0.222 W/mK. In some aspects, display 10 is configured with polydomain LCE to have a thermal diffusivity of about 0.1 to about 0.115 mm²/s. In some aspects, LCE layer 3 is configured with polydomain LCE to have a specific heat of about 1.9 to about 2.04 MJ/m³ k.

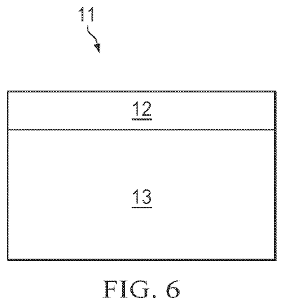

FIG. 6 is a schematic illustration of a light system 11 with a protective LCE layer 12 according to aspects of the disclosure. Light system 11 includes a light source 13 that may be any of a variety of light sources including an LED or array of LEDs, an incandescent light, a laser light, an arc lamp, and the like. In one aspect, light source 13 is an LED or an array of LED lights. LED lights are sensitive electronic components and benefit from the protection that can be provided by LCE layer 12. LCE layer 12 can be formed into a sheet or cover that is secured in place over light source 13, or can be injected in liquid form into a cavity above light source 13 and cured in place. LCE layer 12 is positioned relative to light source 13 so that light emitted from light source 13 passes through LCE layer 12. LCE layer 12 can be fonned from monodomain or polydomain LCE and configured with properties similar to those of LCE layer 3 discussed above. Light source 13 may form part of a large LED display (e.g., LED screens in televisions/monitors, LED video walls typically used in commercial applications). LCE layer 12 may be formed from monodomain LCE when greater transmissivity is desired.

Polydomain LCE can be used when diffusing light from light source 13 is desired. Diffusing the light can help distribute light within a space better to reduce “spot lighting” the space, and can also provide an aesthetic effect that softens the light distribution.

Although various embodiments of the present disclosure have been illustrated in the accompanying Drawings and described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially”, “approximately”, “generally”, and “about” may be substituted with “within [a percentage] of” what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a”, “an”, and other singular terms are intended to include the plural forms thereof unless specifically excluded.

Conditional language used herein, such as, among others, “can”, “might”, “may”, “e.g.”, and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

1. A display surface for a display, the display surface comprising an LCE sheet, wherein the LCE sheet is comprised of monodomain LCE and comprises the following properties:
a haze of about 3%;
a transmission of about 90%;
a sharpness of about 93%; and
a clarity of about 99%.

2. (canceled)

3. The display device of claim 1, wherein the LCE sheet is comprised of monodomain LCE and has a thermal conductivity along the fiber of about 0.33 to about 0.37 W/mK.

4. The display device of claim 1, wherein the LCE sheet is comprised of monodomain LCE and has a thermal conductivity across the fiber of about 0.16 to about 0.19 W/mK.

5. The display device of claim 1, wherein the LCE sheet is comprised of monodomain LCE and has a thermal diffusivity along the fiber of about 0.1 to about 0.115 mm²/s.

6. The display device of claim 1, wherein the LCE sheet is comprised of monodomain LCE and has a thermal diffusivity across the fiber of about 0.07 to about 0.09 mm²/s.

7. The display device of claim 1, wherein the LCE sheet is comprised of polydomain LCE and has a thermal conductivity of about 0.222 W/mK.

8. The display device of claim 1, wherein the LCE sheet is comprised of polydomain LCE and has a thermal diffusivity of about 0.1 to about 0.115 mm²/s.

9. The display device of claim 1, wherein the LCE sheet is comprised of polydomain LCE and has a specific heat of about 1.9 to about 2.04 MJ/m³ k.

10. The display device of claim 1, wherein the display device is an LCD display.

11. The display device of claim 1, wherein the display device is a mobile device.

12. A light system comprising:
a light source; and
a protective LCE layer disposed relative to the light source so that light emitted from the light source passes through the protective LCE layer, wherein the protective LCE layer is comprised of monodomain LCE and comprises the following properties:
a haze of about 3%;
a transmission of about 90%;
a sharpness of about 93%; and
a clarity of about 99%.

13. (canceled)

14. The light system of claim 12, wherein the protective LCE layer is comprised of monodomain LCE and has a thermal conductivity along the fiber of about 0.33 to about 0.37 W/mK.

15. The light system of claim 12, wherein the protective LCE layer is comprised of monodomain LCE and has a thermal conductivity across the fiber of about 0.16 to about 0.19 W/mK.

16. The light system of claim 12, wherein the protective LCE layer is comprised of monodomain LCE and has a thermal diffusivity along the fiber of about 0.1 to about 0.115 mm²/s.

17. The light system of claim 12, wherein the protective LCE layer is comprised of monodomain LCE and has a thermal diffusivity across the fiber of about 0.07 to about 0.09 mm²/s.

18. The light system of claim 12, wherein the protective LCE layer is comprised of polydomain LCE and has a thermal conductivity of about 0.222 W/mK.

19. The light system of claim 12, wherein the protective LCE layer is comprised of polydomain LCE and has a thermal diffusivity of about 0.1 to about 0.115 mm²/s.

20. The light system of claim 12, wherein the protective LCE layer is comprised of polydomain LCE and has a specific heat of about 1.9 to about 2.04 MJ/m³ k.

21. The light system of claim 12, wherein the light source is selected from the group consisting of an LCD display, an OLED display, a mobile device, a table, a smartwatch, an LED, an array of LEDs.

22. The light system of claim 12, wherein the light source is a foldable display.
